(19) United States
(12) Patent Application Publication
(10) Pub. No.: US 2018/0091423 A1
(43) Pub. Date: Mar. 29, 2018

(54) SWITCH AND COMMUNICATION METHOD

(71) Applicant: FUJITSU LIMITED, Kawasaki-shi (JP)

(72) Inventor: Masaki HIROTA, Kawasaki (JP)

(73) Assignee: FUJITSU LIMITED, Kawasaki-shi (JP)

(21) Appl. No.: 15/690,932

(22) Filed: Aug. 30, 2017

(30) Foreign Application Priority Data
Sep. 28, 2016 (JP) 2016-189158

(51) Int. Cl. H04L 12/747; H04L 12/933; H04L 12/743

(52) U.S. Cl. CPC H04L 45/742; H04L 45/7453; H04L 49/10

(57) ABSTRACT

A switch include a memory that stores tree data used for a tree search in which a search for a forwarding destination of received data is made by a tree search system and cache data used for a cache search in which a search for the forwarding destination is made by a cache search system, and a controller that concurrently carries out the tree search and the cache search based on forwarding control identification information included in the received data and decides the forwarding destination of the received data in accordance with a search result that is obtained earlier in search results of the tree search and the cache search.

### CROSS-REFERENCE TO RELATED APPLICATION

This application is based upon and claims the benefit of priority of the prior Japanese Patent Application No. 2016-189158, filed on Sep. 28, 2016, the entire contents of which are incorporated herein by reference.

### FIELD

The embodiments discussed herein are related to a switch and a communication method.

### BACKGROUND

In network environments coupled to the Internet or a virtual private network (VPN), packet switches such as a layer 2 switch (L2SW), L3SW, a router, and OpenFlowSW are widely used.

The packet switch searches a table based on an Internet Protocol (IP) address or the like included in a received packet and decides the contents of processing of each packet. The packet switch carries out virtual local area network (VLAN) tagging, decision of the forwarding destination, and so forth in accordance with the decided contents of processing and transmits the packet.

For such a packet switch, virtualization/software-defined operation is desirable in association with trends toward software defined network (SDN)/network function virtualization (NFV) in recent years. For example, the packet switch carries out a table search in which an IP address is used as a key in a tree search, a cache search, or the like by software processing.

The cache search allows the search time to be almost steady irrespective of the number of entries registered as cache data. However, the cache search has requisite processing time for calculation of the hash function. Furthermore, in the cache search, the search result is not obtained regarding an entry that is not registered as cache data. Moreover, in the cache search, an old entry is replaced by a new entry and thus even an entry that has been once registered possibly becomes an unregistered entry in the process of operation.

On the other hand, in the tree search, the search time increases as the number of branch points of a tree traced until the search result is obtained increases. For this reason, in the tree search, compared with the cache search, the search time is shorter when the number of branch points is smaller and the search time is longer when the number of branch points is larger.

Therefore, the search time in the tree search becomes longer or shorter than the search time in the cache search depending on the number of branch points in the tree search and the cache data in the cache search.

However, when a cache search and a tree search are concurrently carried out, there is the case in which the search result is not obtained in the cache search because the entry is not registered in the cache even when the cache search is expected to be faster than the tree search. Furthermore, in a search method in which a cache search and a tree search are carried out in series, the cache search is first carried out and the tree search is carried out if the search result is not obtained in the cache search. Therefore, the search time is long if the entry is not registered in the cache.

The followings are reference documents.

[Document 1] Japanese Laid-open Patent Publication No. 2013-42320,

[Document 2] Japanese Laid-open Patent Publication No. 2001-168910, and

[Document 3] Japanese Laid-open Patent Publication No. 11-232285.

### SUMMARY

According to an aspect of the embodiments, a switch include a memory that stores tree data used for a tree search in which a search for a forwarding destination of received data is made by a tree search system and cache data used for a cache search in which a search for the forwarding destination is made by a cache search system, and a controller that concurrently carries out the tree search and the cache search based on forwarding control identification information included in the received data and decides the forwarding destination of the received data in accordance with a search result that is obtained earlier in search results of the tree search and the cache search.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a configuration of a switch of a first embodiment;

FIG. 2 is a diagram illustrating one example of a configuration of a network system of a second embodiment;

FIG. 3 is a diagram illustrating one example of a hardware configuration of an L2SW of the second embodiment;

FIG. 4 is a diagram illustrating one example of a functional configuration of an L2SW of the second embodiment;

FIG. 5 is a diagram illustrating one example of a process of packet forwarding of the second embodiment;

FIG. 6 is a diagram illustrating one example of a tree table of the second embodiment;

FIG. 7 is a diagram illustrating one example of a cache table of the second embodiment;

FIG. 8 is a diagram illustrating an example of comparison between search time of a tree search and search time of a cache search in the second embodiment;

FIG. 9 is a diagram illustrating a flowchart of search processing of the second embodiment;

FIG. 10 is a diagram illustrating one example of a received-number-of-nodes management table of the second embodiment;

FIG. 11 is a diagram illustrating a flowchart of search processing of a third embodiment;

FIG. 12 is a diagram illustrating a flowchart of cache-use threshold determination table update processing of the third embodiment;

FIG. 13 is a diagram illustrating one example (first example) of a cache-use threshold determination table of the third embodiment;

FIG. 14 is a diagram illustrating one example (second example) of a cache-use threshold determination table of the third embodiment;

FIG. 15 is a diagram illustrating one example (third example) of a cache-use threshold determination table of the third embodiment;

FIG. 16 is a diagram illustrating one example (fourth example) of a cache-use threshold determination table of the third embodiment;

FIG. 17 is a diagram illustrating a flowchart of search processing of a fourth embodiment;

FIG. 18 is a diagram illustrating a cache registration determination example of the fourth embodiment;

FIG. 19 is a diagram illustrating a flowchart of cache registration processing of a fifth embodiment;

FIG. 20 is a diagram illustrating one example (first example) of a cache table of the fifth embodiment;

FIG. 21 is a diagram illustrating one example (second example) of a cache table of the fifth embodiment;

FIG. 22 is a diagram illustrating one example of a functional configuration of an L2SW of a sixth embodiment;

FIG. 23 is a diagram illustrating a flowchart of cache registration processing of the sixth embodiment;

FIG. 24 is a diagram illustrating one example (first example) of a cache table of the sixth embodiment; and

FIG. 25 is a diagram illustrating one example (second example) of a cache table of the sixth embodiment.

### DESCRIPTION OF EMBODIMENTS

Embodiments will be described in detail below with reference to the drawings.

### First Embodiment

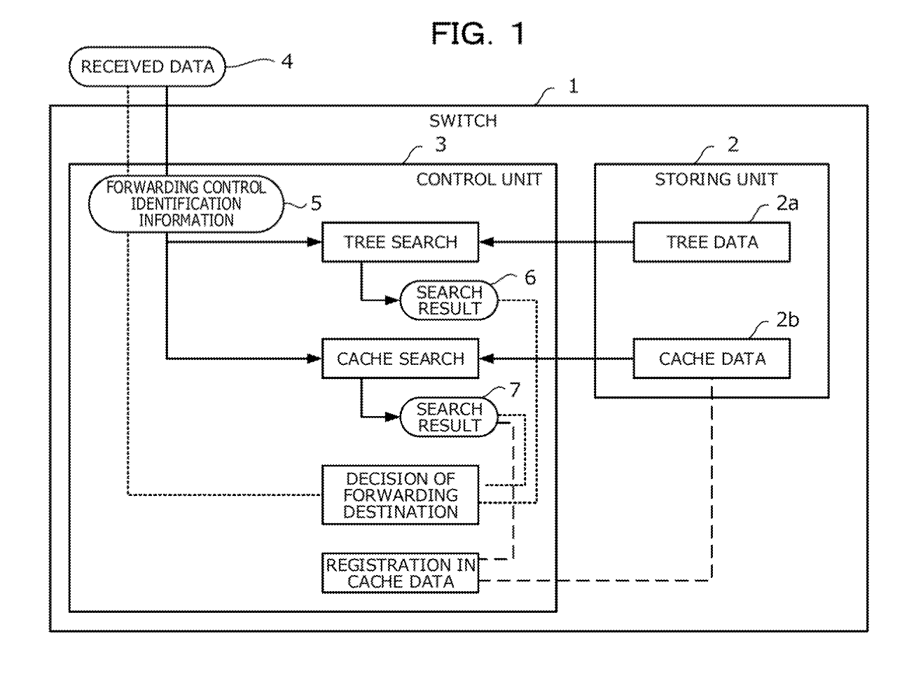

First, a switch of a first embodiment will be described by using FIG. 1. FIG. 1 is a diagram illustrating one example of the configuration of the switch of the first embodiment.

A switch 1 is a data forwarding device that forwards received data 4. For example, the switch 1 is a packet switch (packet forwarding device) that treats an IP packet as forwarding-target data. For example, the switch 1 may be L2SW, L3SW, router, OpenFlow SW, or the like.

The switch 1 includes a memory 2 and a control unit 3. The memory 2 stores tree data 2a and cache data 2b. The tree data 2a is data used for a tree search in which a search for the forwarding destination of the received data 4 is carried out by a tree search system. The tree data 2a is data prepared in advance prior to the tree search.

The cache data 2b is data used for a cache search in which a search for the forwarding destination of the received data 4 is carried out by a cache search system. The cache data 2b is data updated in accordance with the result of the cache search.

The control unit 3 concurrently carries out the tree search and the cache search based on forwarding control identification information 5. For example, the control unit 3 carries out the tree search with use of the forwarding control identification information 5 as a search key and carries out the cache search with use of the forwarding control identification information 5 as a search key.

The forwarding control identification information 5 is included in the received data 4. The forwarding control identification information 5 is identification information used for forwarding control of the received data 4. The forwarding control includes decision of the forwarding destination, for example. As the forwarding control identification information 5, the destination IP address included in an IP packet, the Media Access Control (MAC) address included in an Ethernet (registered trademark) frame, and so forth exist.

The control unit 3 decides the forwarding destination of the received data 4 in accordance with the search result obtained first in a search result 6 obtained from the tree search and a search result 7 obtained from the cache search. For example, when obtaining the search result 6 from the tree search earlier than from the cache search, the control unit 3 decides the forwarding destination of the received data 4 in accordance with the search result 6. Furthermore, when obtaining the search result 7 from the cache search earlier than from the tree search, the control unit 3 decides the forwarding destination of the received data 4 in accordance with the search result 7.

If the control unit 3 obtains the search result 6 from the tree search (search hit) and does not obtain the search result 7 from the cache search (search mishit), the control unit 3 decides the forwarding destination of the received data 4 in accordance with the search result 6. Hereinafter, the search hit will be referred to simply as a hit and the search mishit will be referred to simply as a mishit. Furthermore, the control unit 3 executes mishit processing if the search result 6 is not obtained from the tree search.

If the cache search results in a mishit, the control unit 3 determines whether or not to carry out registration in the cache data 2b from the search result 6 (hit) and the search result 7 (mishit). If the control unit 3 carries out registration in the cache data 2b without exception when the cache search results in a mishit, an old entry is often deleted instead of a newly-added entry. This improves the cache search performance in some cases. However, when the switch 1 is viewed in terms of the relationship with the tree search carried out concurrently, possibly the search performance is impaired.

For example, when registration in the cache data 2b is carried out regarding a search key with which the search time of the cache search is longer than the search time of the tree search, although the cache search does not result in a mishit in the next and subsequent searches, the search result of the cache search is not selected because the search time is longer than the tree search. For example, the registration of the search key with which the search time of the cache search is longer than the search time of the tree search in the cache data 2b does not contribute to shortening of the search time as the switch 1. Moreover, the registration of the search key with which the search time of the cache search is longer than the search time of the tree search in the cache data 2b deletes a search key with which the search time of the cache search is shorter than the search time of the tree search from the cache data 2b. Such update of the cache data 2b increases the search time as the switch 1.

Therefore, if the search result of the cache search is a mishit and if the cache search may obtain the search result earlier than the tree search, the control unit 3 registers the entry corresponding to the forwarding control identification information 5 in the cache data 2b. In other words, if the search result of the cache search is a mishit, the control unit 3 does not register, in the cache data 2b, the entry that does not have the expectation that the cache search may obtain the search result earlier than the tree search.

Due to this, in the cache data 2b, the entry with which the cache search may obtain the search result earlier than the tree search may be registered in priority to the entry with which the cache search does not obtain the search result earlier than the tree search.

Therefore, the control unit 3 may enhance the hit ratio of the cache search when the cache search may obtain the search result earlier than the tree search. Due to this, when carrying out the cache search and the tree search, the switch 1 may improve the cache search performance and thus improve the overall search performance. For example, the switch 1 may improve the cache search performance when concurrently carrying out the cache search and the tree search. Furthermore, the switch 1 may improve the cache search performance compared with the search method in which the cache search is first carried out and the tree search is carried out if the search result is not obtained in the cache search.

### Second Embodiment

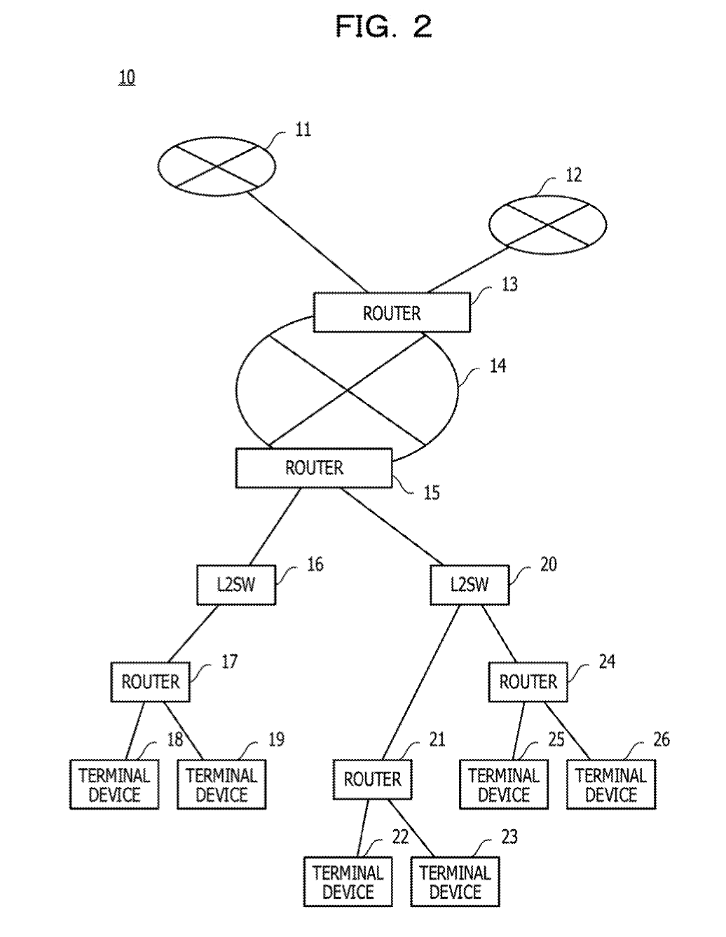

Next, a network system of a second embodiment will be described by using FIG. 2. FIG. 2 is a diagram illustrating one example of the configuration of the network system of the second embodiment.

A network system 10 includes plural networks such as a VPN core NW 11, an ISP 12, and a core/metro NW 14 and plural terminal devices such as terminal devices 18, 19, 22, 23, 25, and 26. The network system 10 further includes data forwarding devices (switches) such as routers 13, 15, 17, 21, and 24 and L2SWs 16 and 20 and couples the plural networks and the plural terminal devices.

Due to this, the network system 10 offers an environment for coupling to the Internet and a VPN. At this time, the data forwarding devices decide the forwarding destination of a received IP packet and transmit the received IP packet to the decided forwarding destination. The data forwarding devices forward the IP packet at high speed and thereby contribute to construction of a high-speed network communication environment.

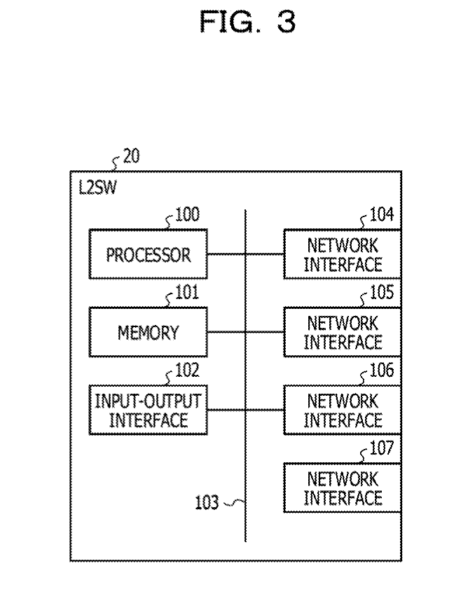

Next, the hardware configuration and functional configuration of the data forwarding device will be described by taking the L2SW 20 as one example as a representative. First, the hardware configuration of the L2SW 20 will be described by using FIG. 3. FIG. 3 is a diagram illustrating one example of the hardware configuration of the L2SW of the second embodiment.

In the L2SW 20, the whole device is controlled by a processor 100. For example, the processor 100 functions as a control unit of the L2SW 20. To the processor 100, a memory 101 and plural pieces of peripheral equipment are coupled through a bus 103. The processor 100 may be a multiprocessor. The processor 100 is a central processing unit (CPU), a micro processing unit (MPU), a digital signal processor (DSP), an application specific integrated circuit (ASIC) or a programmable logic device (PLD), for example. Furthermore, the processor 100 may be a combination of two or more elements among CPU, MPU, DSP, ASIC, and PLD.

The memory 101 is used as a main storing device of the L2SW 20. In the memory 101, at least part of a program of an operating system (OS) or an application program to be executed by the processor 100 is temporarily stored. Furthermore, various kinds of data for processing by the processor 100 are stored in the memory 101.

Moreover, the memory 101 is used also as an auxiliary storing device of the L2SW 20 and the program of the OS, application programs, and various kinds of data are stored therein. The memory 101 may include a semiconductor storing device such as a flash memory or a solid state drive (SSD) and a magnetic recording medium such as a hard disk drive (HDD) as the auxiliary storing device.

As the pieces of peripheral equipment coupled to the bus 103, an input-output interface 102 and network interfaces 104, 105, 106, and 107 exist.

To the input-output interface 102, a monitor (for example, light emitting diode (LED), liquid crystal display (LCD), or the like) functioning as a display device that displays the state of the L2SW 20 in accordance with a command from the processor 100 is coupled. Furthermore, information input devices such as a keyboard and a mouse may be coupled to the input-output interface 102 and the input-output interface 102 transmits signals from the information input devices to the processor 100.

Moreover, the input-output interface 102 functions as a communication interface for coupling of peripheral equipment. For example, to the input-output interface 102, an optical drive device that reads data recorded in an optical disc by using laser light or the like may be coupled. The optical disc is a portable recording medium in which data is so recorded as to be allowed to be read based on light reflection. As the optical discs, digital versatile disc (DVD), DVD-random access memory (DVD-RAM), compact disc read only memory (CD-ROM), CD-recordable (R)/rewritable (RW), and so forth exist.

Furthermore, a memory device or a memory reader/writer may be coupled to the input-output interface 102. The memory device is a recording medium equipped with a function of communication with the input-output interface 102. The memory reader/writer is a device that carries out writing of data to a memory card or reading of data from the memory card. The memory card is a recording medium of a card type.

The network interfaces 104, 105, 106, and 107 carry out transmission and reception of data with communication equipment serving as the forwarding source or forwarding destination of the data. For example, the network interfaces 104, 105, 106, and 107 each correspond to a transmission port.

By the above-described hardware configuration, the L2SW 20 may implement processing functions of the second embodiment. For example, the processor 100 executes the respective given programs and thereby the L2SW 20 functions as the data forwarding device and may carry out data forwarding.

For example, the L2SW 20 implements processing functions of the second embodiment by executing a program recorded in a computer-readable recording medium. The program in which the contents of processing to be executed by the L2SW 20 are described may be recorded in various recording media. For example, the program to be executed by the L2SW 20 may be stored in the auxiliary storing device. The processor 100 loads at least part of the program in the auxiliary storing device into the main storing device and executes the program. Furthermore, it is also possible to record the program to be executed by the L2SW 20 in a portable recording medium such as an optical disc, a memory device, or a memory card. The program stored in the portable recording medium is installed on the auxiliary storing device by control from the processor 100, for example, and then becomes executable. Moreover, it is also possible for the processor 100 to directly read out the program from the portable recording medium and execute the program.

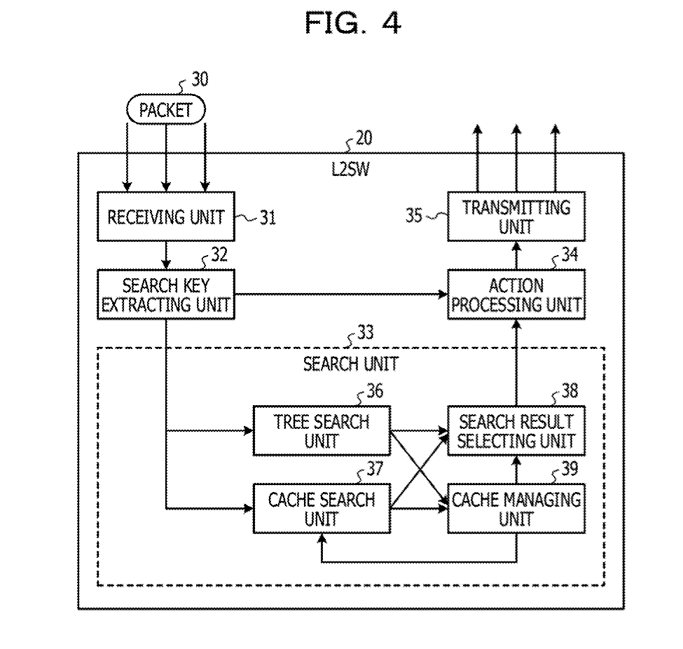

Next, the functional configuration of the L2SW 20 will be described by using FIG. 4. FIG. 4 is a diagram illustrating one example of the functional configuration of the L2SW of the second embodiment.

The L2SW 20 includes a receiving unit 31, a search key extracting unit 32, a search unit 33, an action processing unit 34, and a transmitting unit 35. The receiving unit 31 receives a packet (IP packet) 30. The search key extracting unit 32 extracts a search key (equivalent to the forwarding control identification information 5 of the first embodiment) from the packet 30. The search key extracting unit 32 outputs the extracted search key to the search unit 33 and outputs the packet 30 to the action processing unit 34.

The search unit 33 carries out a search based on the input search key and outputs the search result to the action processing unit 34. The search unit 33 includes a tree search unit 36, a cache search unit 37, a search result selecting unit 38, and a cache managing unit 39. The tree search unit 36 searches a tree table by a tree search system with use of the search key. The cache search unit 37 searches a cache table by a cache search system with use of the search key.

The search result selecting unit 38 selects the search result obtained earlier in a search result obtained from the tree search unit 36 and a search result obtained from the cache search unit 37 and outputs the search result to the action processing unit 34. If the search by the cache search unit 37 results in a mishit, the search result selecting unit 38 selects the search result obtained from the tree search unit 36 and outputs the search result to the action processing unit 34. Furthermore, the search result selecting unit 38 executes mishit processing if both searches by the tree search unit 36 and the cache search unit 37 result in a mishit. The cache managing unit 39 updates the cache table based on the search result obtained from the tree search unit 36 and the search result obtained from the cache search unit 37.

The action processing unit 34 executes action processing corresponding to the packet 30 in accordance with the search result and outputs the packet 30 to the transmitting unit 35. The action processing executed by the action processing unit 34 includes forwarding, VLAN tagging, and so forth. Furthermore, the action processing includes packet filtering, address conversion, and so forth depending on the type of the data forwarding device (router or the like). The transmitting unit 35 transmits the packet 30 to the forwarding destination in accordance with the action processing.

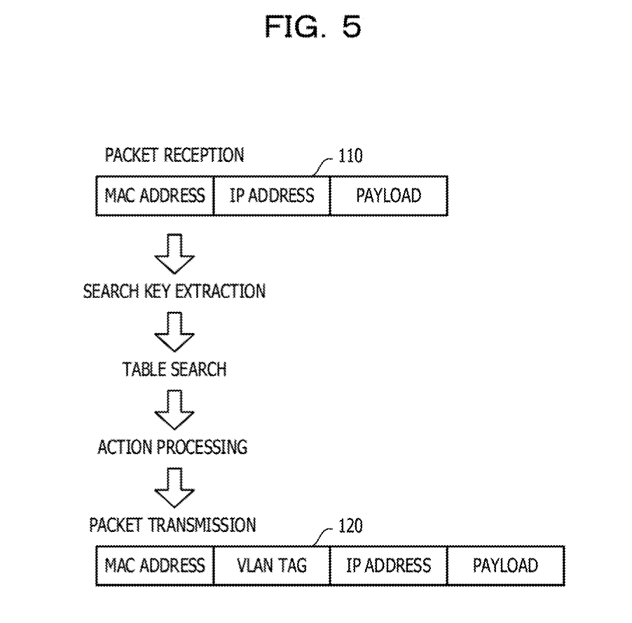

Here, the process of packet forwarding will be described by using FIG. 5. FIG. 5 is a diagram illustrating one example of the process of packet forwarding of the second embodiment.

The L2SW 20 receives a packet 110. The packet 110 includes a destination MAC address (MAC address of the L2SW 20), a destination IP address, and a payload. The L2SW 20 extracts the destination IP address as a search key. The L2SW 20 carries out a table search by using the destination IP address as the search key. The term table search here refers to a concurrent search of a tree search and a cache search. The L2SW 20 executes the action processing based on the search result. For example, the L2SW 20 carries out VLAN tagging and replacement of the destination MAC address (MAC address of the forwarding destination) and generates a packet 120. The L2SW 20 transmits the packet 120 to the forwarding destination.

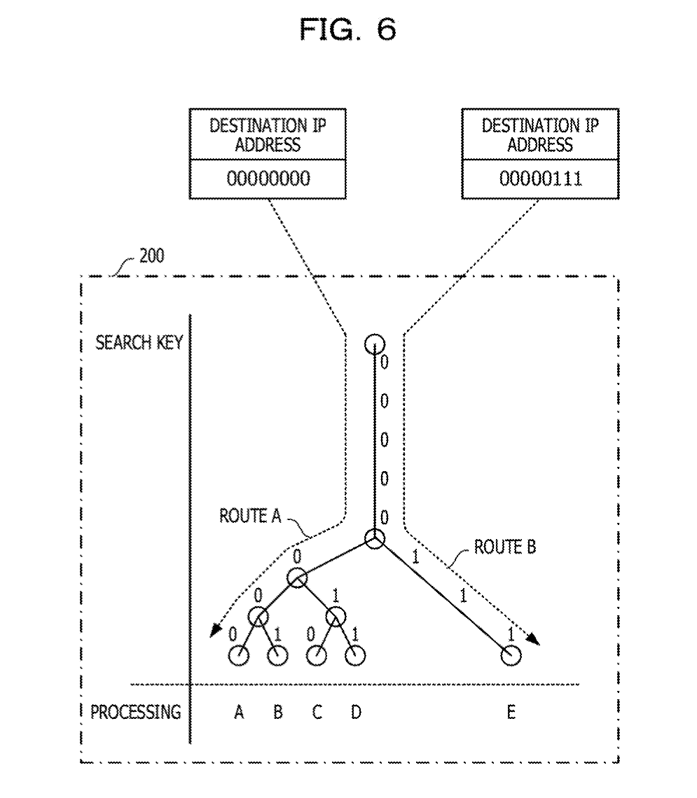

Next, the tree table will be described by using FIG. 6. FIG. 6 is a diagram illustrating one example of the tree table of the second embodiment.

A tree table 200 is data prepared in a tree search in advance and is stored in the memory 101. The tree table 200 is one mode of the forwarding table and has a tree structure that branches in accordance with the bit pattern of the destination IP address (search key). For example, the tree table 200 has a tree structure obtained by merging for each common value from the most significant bit (MSB) side of the IP address. For simplification of explanation, the description will be made in such a manner that the 32-bit IP address in IPv4 is deemed as an 8-bit IP address.

Suppose that the tree table 200 includes five entries and the search keys of the respective entries are “00000000,” “00000001,” “00000010,” “00000011,” and “00000111.” Processing (action processing) is associated with each search key and the corresponding processing is deemed as the search result. For example, processing A is associated with the search key “00000000” and processing E is associated with the search key “00000111.”

The search keys “00000000,” “00000001,” “00000010,” and “00000011” include five branch points including a start point and an end point. The search key “00000111” includes three branch points. Hereinafter, the number of branch points will be referred to as the number of nodes.

The tree search unit 36 traces the tree while deciding the branch destination for each branch point in accordance with the bit value from the MSB side. Thus, a search key with a larger number of nodes takes a longer search time. For example, the tree search unit 36 takes a longer search time with the search key “00000000” than with the search key “00000111” because the number of nodes is “5” with the search key “00000000” (search route A) and the number of nodes is “3” with the search key “00000111” (search route B).

Due to this, because the number of nodes and the search time in the tree search have a correspondence relationship, the L2SW 20 may compare the search time by comparing the number of nodes. Furthermore, because the search time of the cache search is almost steady, the L2SW 20 may compare the search time between the cache search and the tree search by comparing the number of nodes corresponding to the search key used in the cache search and the number of nodes in the tree search.

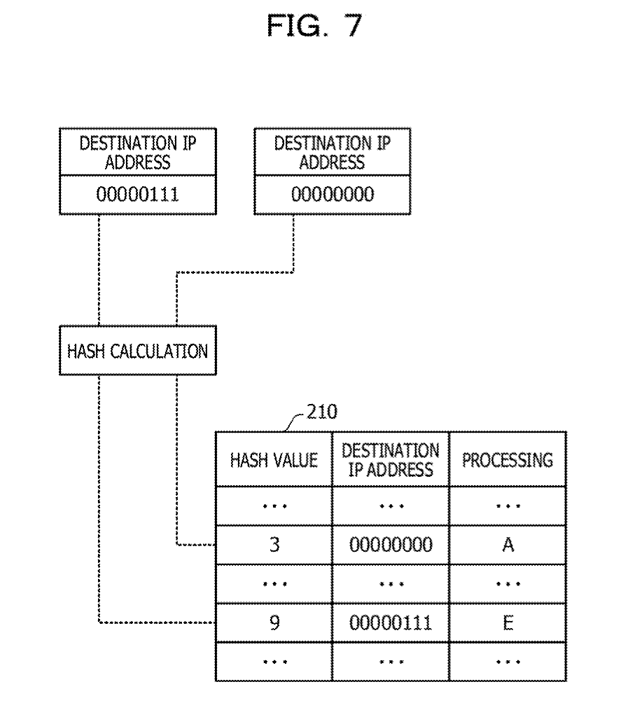

Next, the cache table will be described by using FIG. 7. FIG. 7 is a diagram illustrating one example of the cache table of the second embodiment.

A cache table 210 is data updated in the cache search and is stored in the memory 101. The cache table 210 is one mode of the forwarding table and has a table data structure including a hash value of the destination IP address (search key) as an index. For example, the cache table 210 includes an item “hash value,” an item “destination IP address,” and an item “processing.”

The item “hash value” indicates the result of hash calculation when the destination IP address (search key) is deemed as an input value. For example, the hash value is “3” for the search key “00000000” and the hash value is “9” for the search key “00000111.”

The cache search unit 37 carries out a hash-system all-bit match search (exact match (EM)-HASH). The cache search unit 37 searches the cache table 210 by using the hash value obtained by the hash calculation of the destination IP address as the index.

When the search by the cache search unit 37 results in a mishit, a new entry is added to the cache table 210. The cache table 210 includes a given number of entries and an old entry is deleted when a new entry is additionally registered.

The destination IP address and processing (action processing) are associated with each hash value and the corresponding processing is deemed as the search result. For example, the destination IP address “00000000” and processing A are associated with the hash value “3” and the destination IP address “00000111” and processing E are associated with the hash value “9.”

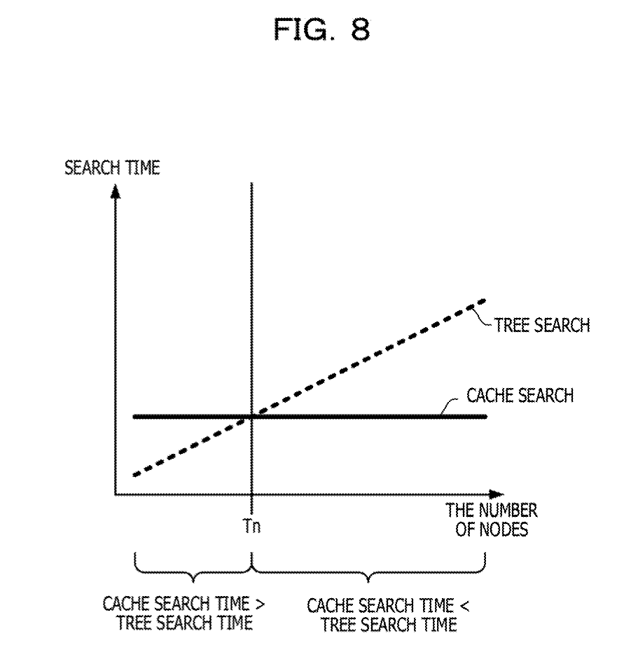

Next, the search time of the tree search and the search time of the cache search will be described by using FIG. 8. FIG. 8 is a diagram illustrating an example of comparison between the search time of the tree search and the search time of the cache search in the second embodiment.

The cache search unit 37 carries out the hash calculation and thus often takes a longer time than the tree search unit 36. However, the cache search unit 37 may obtain the search result in an almost steady search time without depending on the number of entries.

On the other hand, the tree search has a characteristic that the search time increases according to the number of nodes. Thus, the tree search takes a shorter search time than the cache search when the number of nodes is smaller than a threshold Tn, and takes a longer search time than the cache search when the number of nodes is larger than the threshold Tn.

For this reason, when concurrently executing the cache search and the tree search, the L2SW 20 improves the search time by enhancing the hit ratio in the cache search with a search key with which the number of nodes is larger than the threshold Tn.

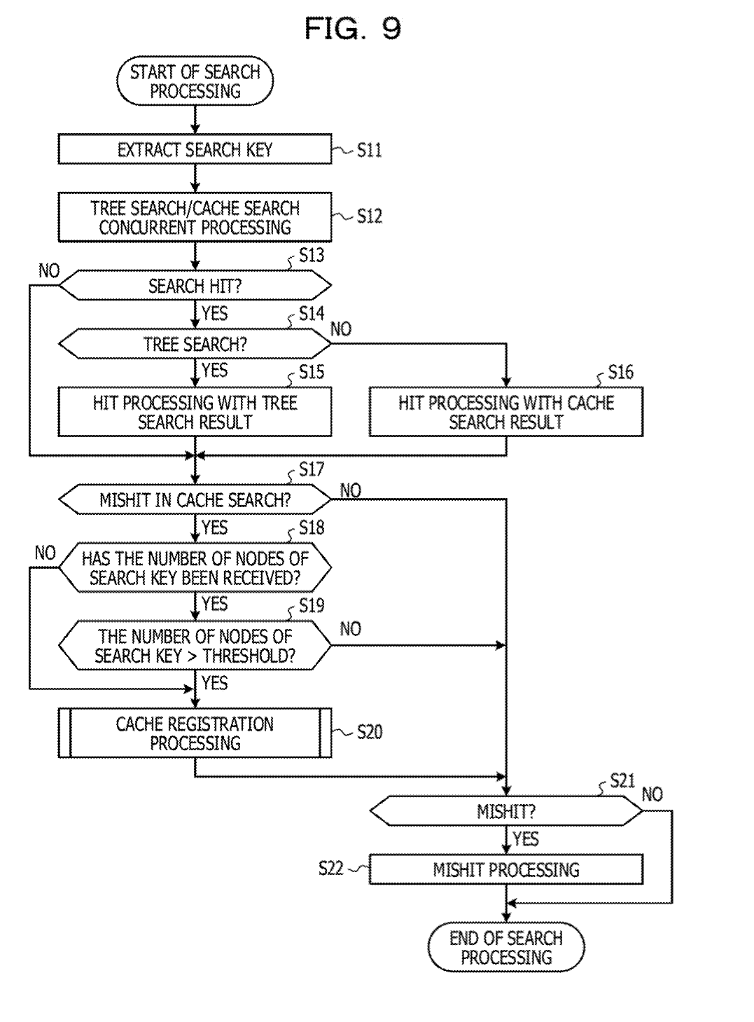

Next, search processing for enhancing the hit ratio in the cache search will be described by using FIG. 9. FIG. 9 is a diagram illustrating a flowchart of the search processing of the second embodiment.

The search processing is processing in which a cache search and a tree search are concurrently executed to obtain the search result. The search processing is processing executed by the search unit 33.

[Step S11] The search unit 33 extracts a search key (destination IP address) from a received packet.

[Step S12] The search unit 33 concurrently processes the tree search and the cache search by using the search key. For example, the search unit 33 simultaneously executes the tree search and the cache search by using a multi-core CPU, or the like.

[Step S13] The search unit 33 determines whether or not either the tree search or the cache search has resulted in a search hit (search result is a hit). The search unit 33 proceeds to a step S14 if either the tree search or the cache search has resulted in a search hit, and proceeds to a step S17 if neither has resulted in a search hit (both have resulted in a mishit).

[Step S14] The search unit 33 determines whether or not the tree search has resulted in a hit. The search unit 33 proceeds to a step S15 if the tree search has resulted in a hit, and proceeds to a step S16 if the tree search has not resulted in a hit, i.e. if the cache search has resulted in a hit.

[Step S15] The search unit 33 executes hit processing with the tree search result. For example, the search unit 33 outputs the search result by the tree search to the action processing unit 34.

[Step S16] The search unit 33 executes the hit processing with the cache search result. For example, the search unit 33 outputs the search result by the cache search to the action processing unit 34.

This allows the search unit 33 to execute the hit processing by using the search result obtained earlier in the search results of the tree search and the cache search.

[Step S17] The search unit 33 determines whether or not the cache search has resulted in a mishit. The search unit 33 proceeds to a step S18 if the cache search has resulted in a mishit, and proceeds to a step S21 if the cache search has not resulted in a mishit.

[Step S18] The search unit 33 determines whether or not the number of nodes of the search key has been received (search with the number of nodes has been carried out) by using a received-number-of-nodes management table. The search unit 33 proceeds to a step S19 if the number of nodes of the search key has been received, and proceeds to a step S20 if the number of nodes of the search key has not been received.

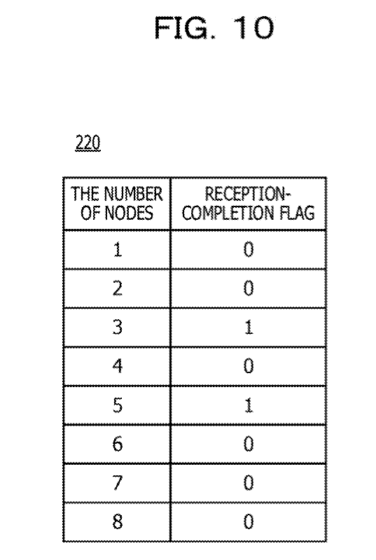

The received-number-of-nodes management table is a table to manage whether or not data has been received regarding each number of nodes. Furthermore, the search unit 33 may acquire the number of nodes of the search key used for the cache search from the tree search result. The received-number-of-nodes management table will be described later by using FIG. 10.

[Step S19] The search unit 33 determines whether or not the number of nodes of the search key is larger than a threshold set in advance. The search unit 33 proceeds to the step S20 if the number of nodes of the search key is larger than the threshold, and proceeds to the step S21 if the number of nodes of the search key is not larger (is smaller) than the threshold. The threshold is a value set in advance by using an empirical value, a design value, or the like and is stored in the memory 101.

[Step S20] The search unit 33 executes cache registration processing. The cache registration processing is processing of registering the entry corresponding to the search key in the cache table 210. Furthermore, in the second embodiment, the search unit 33 updates the received-number-of-nodes management table in the cache registration processing. For example, when it is indicated that the number of nodes of the search key has not yet been received in the received-number-of-nodes management table, the search unit 33 updates the state of reception of the number of nodes to the reception-completed state.

In this manner, the search unit 33 registers the entry corresponding to the search key in the cache table 210 if the number of nodes of the search key has not been received. Furthermore, if the number of nodes of the search key has been received, the search unit 33 registers the entry corresponding to the search key in the cache table 210 if the number of nodes of the search key is larger than the threshold.

This allows the search unit 33 to improve the search hit ratio in the cache search when the search result is obtained in the cache search earlier than in the tree search. On the other hand, in some cases, the search unit 33 lowers the search hit ratio in the cache search when the search result is obtained in the cache search later than in the tree search. However, the lowering of the search hit ratio when the search result is obtained later than in the tree search does not become a problem because the search unit 33 executes the hit processing by using the search result obtained earlier in the search results of the tree search and the cache search. As a result, the search unit 33 improves the search performance when the search unit 33 concurrently carries out the tree search and the cache search.

[Step S21] The search unit 33 determines whether or not both of the tree search and the cache search have resulted in a search mishit (search result is a mishit). The search unit 33 proceeds to a step S22 if both of the tree search and the cache search have resulted in a search mishit, and ends the search processing if either has resulted in a search hit.

[Step S22] The search unit 33 executes the mishit processing and ends the search processing.

Next, the received-number-of-nodes management table will be described by using FIG. 10. FIG. 10 is a diagram illustrating one example of the received-number-of-nodes management table of the second embodiment.

A received-number-of-nodes management table 220 is a table to manage whether or not data has been received regarding each number of nodes. The received-number-of-nodes management table 220 includes an item “the number of nodes” and an item “reception-completion flag.” The item “the number of nodes” indicates the number of nodes corresponding to the search key in the tree search. For example, the item “the number of nodes” includes eight records of “1” to “8” when a search of 8 bits is carried out in the tree search. The item “reception-completion flag” indicates whether or not data has been received regarding each number of nodes, for example, whether or not the search with the search key has been carried out regarding each number of nodes. The item “reception-completion flag” is “0 (=data has not been received)” in all records as the initial state and is updated to “1 (=data has been received)” every data reception.

For example, the received-number-of-nodes management table 220 indicates that data has not been received regarding the numbers of nodes “1,” “2,” “4,” “6,” “7,” and “8” and data has been received regarding the numbers of nodes “3” and “5.”

By using the received-number-of-nodes management table 220, the search unit 33 may register, in the cache table 210, the entry corresponding to the search key with the number of nodes regarding which data has not been received. Furthermore, by using the received-number-of-nodes management table 220, the search unit 33 may register, in the cache table 210, the entry corresponding to the search key with the number of nodes regarding which data has been received after comparison with the threshold.

### Third Embodiment

Next, an L2SW of a third embodiment will be described. The L2SW of the third embodiment is different in that the L2SW of the third embodiment dynamically decides a threshold, which is statically decided in the search processing of the second embodiment, in search processing.

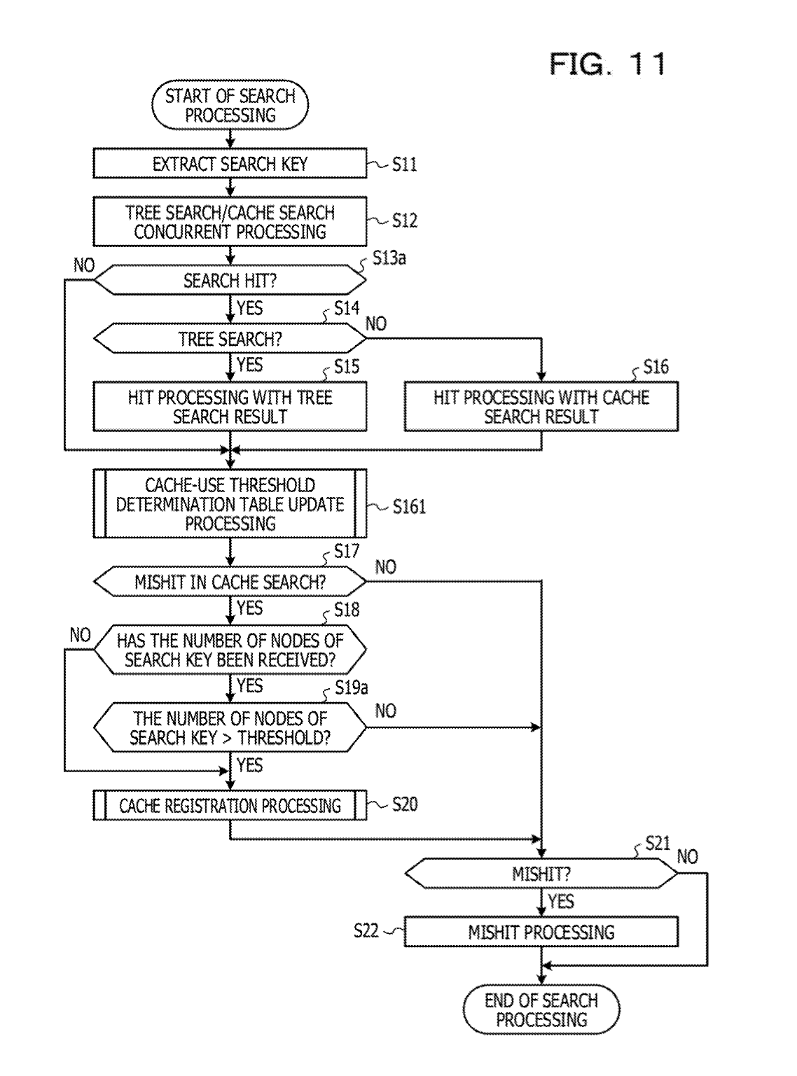

First, the search processing of the third embodiment will be described by using FIG. 11. FIG. 11 is a diagram illustrating a flowchart of the search processing of the third embodiment.

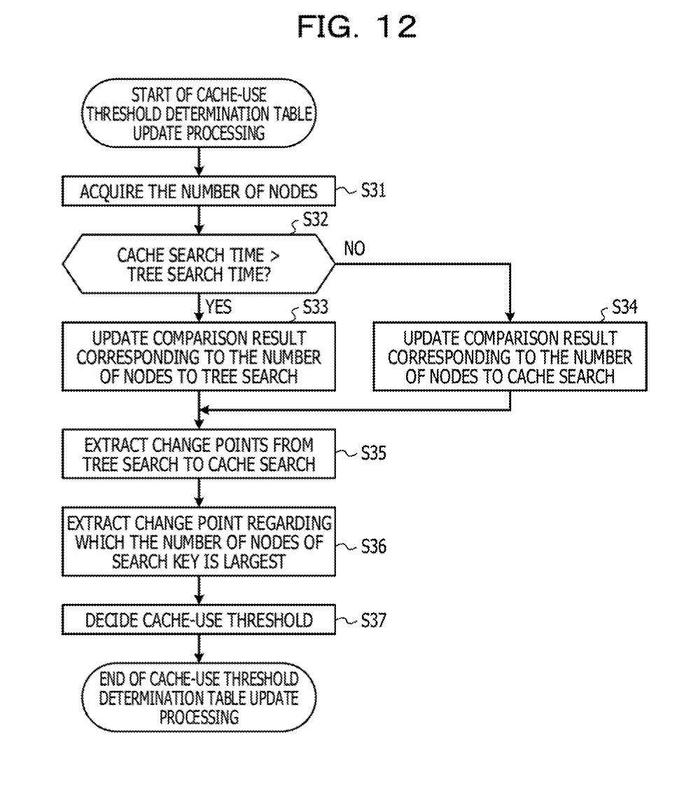

The search processing is processing in which a cache search and a tree search are concurrently executed to obtain the search result. The search processing is processing executed by the search unit 33. The same processing as the search processing of the second embodiment is given the same step number and description thereof is simplified.

[Step S11] The search unit 33 extracts a search key (destination IP address) from a received packet.

[Step S12] The search unit 33 concurrently processes the tree search and the cache search by using the search key.

[Step S13a] The search unit 33 determines whether or not either the tree search or the cache search has resulted in a search hit. The search unit 33 proceeds to the step S14 if either the tree search or the cache search has resulted in a search hit, and proceeds to a step S161 if neither has resulted in a search hit.

[Step S14] The search unit 33 determines whether or not the tree search has resulted in a hit. The search unit 33 proceeds to the step S15 if the tree search has resulted in a hit, and proceeds to the step S16 if the tree search has not resulted in a hit.

[Step S15] The search unit 33 executes the hit processing with the tree search result.

[Step S16] The search unit 33 executes the hit processing with the cache search result.

[Step S161] The search unit 33 executes cache-use threshold determination table update processing. The cache-use threshold determination table update processing is processing of dynamically updating a threshold used for determination of cache registration by using a cache-use threshold determination table. The cache-use threshold determination table update processing will be described later by using FIG. 12.

[Step S17] The search unit 33 determines whether or not the cache search has resulted in a mishit. The search unit 33 proceeds to the step S18 if the cache search has resulted in a mishit, and proceeds to the step S21 if the cache search has not resulted in a mishit.

[Step S18] The search unit 33 determines whether or not the number of nodes of the search key has been received by using the received-number-of-nodes management table. The search unit 33 proceeds to a step S19a if the number of nodes of the search key has been received, and proceeds to the step S20 if the number of nodes of the search key has not been received.

[Step S19a] The search unit 33 determines whether or not the number of nodes of the search key is larger than the threshold dynamically updated (cache-use threshold). The search unit 33 proceeds to the step S20 if the number of nodes of the search key is larger than the cache-use threshold, and proceeds to the step S21 if the number of nodes of the search key is not larger (is smaller) than the cache-use threshold.

[Step S20] The search unit 33 executes the cache registration processing.

[Step S21] The search unit 33 determines whether or not both of the tree search and the cache search have resulted in a search mishit. The search unit 33 proceeds to the step S22 if both of the tree search and the cache search have resulted in a search mishit, and ends the search processing if either has resulted in a search hit.

[Step S22] The search unit 33 executes the mishit processing and ends the search processing.

Next, the cache-use threshold determination table update processing of the third embodiment will be described by using FIG. 12. FIG. 12 is a diagram illustrating a flowchart of the cache-use threshold determination table update processing of the third embodiment.

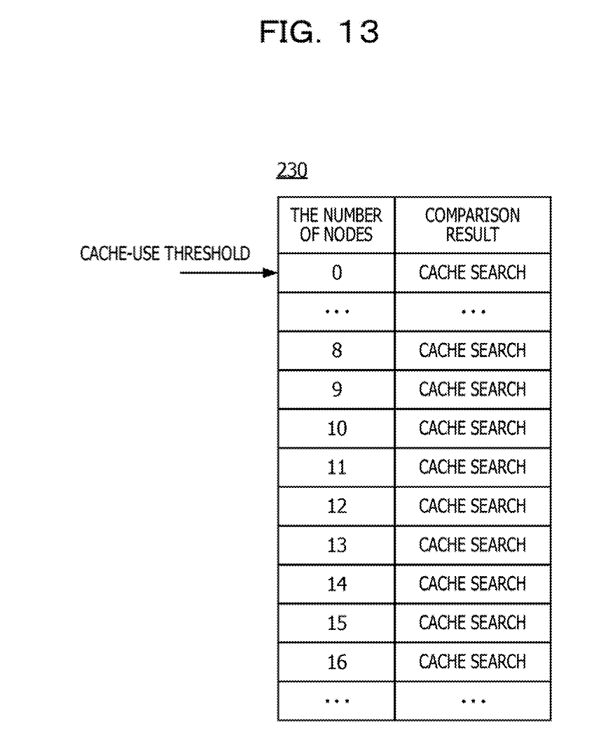

The cache-use threshold determination table update processing is processing of dynamically updating the threshold used for determination of cache registration by using the cache-use threshold determination table. The cache-use threshold determination table update processing is processing executed by the search unit 33 in the step S161 of the search processing.

[Step S31] The search unit 33 acquires the number of nodes of the search key.

[Step S32] The search unit 33 compares the cache search time taken for the cache search to obtain the search result and the tree search time taken for the tree search to obtain the search result. The search unit 33 proceeds to a step S33 when the cache search time is longer than the tree search time, and proceeds to a step S34 when the cache search time is not longer than the tree search time.

[Step S33] The search unit 33 updates the comparison result corresponding to the number of nodes of the search key in the cache-use threshold determination table to “tree search.” The cache-use threshold determination table will be described by using FIG. 13 to FIG. 16.

[Step S34] The search unit 33 updates the comparison result corresponding to the number of nodes of the search key in the cache-use threshold determination table to “cache search.”

[Step S35] The search unit 33 refers to the cache-use threshold determination table and extracts change points from the comparison result “tree search” to the comparison result “cache search.”

[Step S36] The search unit 33 extracts the change point regarding which the number of nodes of the search key is the largest among the extracted change points.

[Step S37] The search unit 33 decides the cache-use threshold in accordance with the change point regarding which the number of nodes of the search key is the largest, and ends the cache-use threshold determination table update processing.

Next, the cache-use threshold determination table and the process of updating of the cache-use threshold determination table in the cache-use threshold determination table update processing will be described by using FIG. 13 to FIG. 16. First, description will be made by using FIG. 13 about the initial state of the cache-use threshold determination table and the initial value of the threshold used for determination of whether or not to carry out cache registration (cache-use threshold). FIG. 13 is a diagram illustrating one example (first example) of the cache-use threshold determination table of the third embodiment.

A cache-use threshold determination table 230 is a table used for decision of the cache-use threshold. The cache-use threshold determination table 230 includes an item “the number of nodes” and an item “comparison result.” The item “the number of nodes” indicates the number of nodes corresponding to the search key in the tree search. For example, the item “the number of nodes” includes 32 records of “1” to “32” when a search of 32 bits is carried out in the tree search. The item “comparison result” indicates which of the tree search and the cache search is shorter in the search time. The item “comparison result” is “cache search” in all records as the initial state and is updated to “tree search” when the tree search time is shorter than the cache search time.

For example, the cache-use threshold determination table 230 indicates that the comparison result is “cache search” regarding all of the numbers of nodes from “1” to “32.” At this time, the change point from the comparison result “tree search” to the comparison result “cache search” does not exist and thus the search unit 33 sets the cache-use threshold to “0” as the initial value.

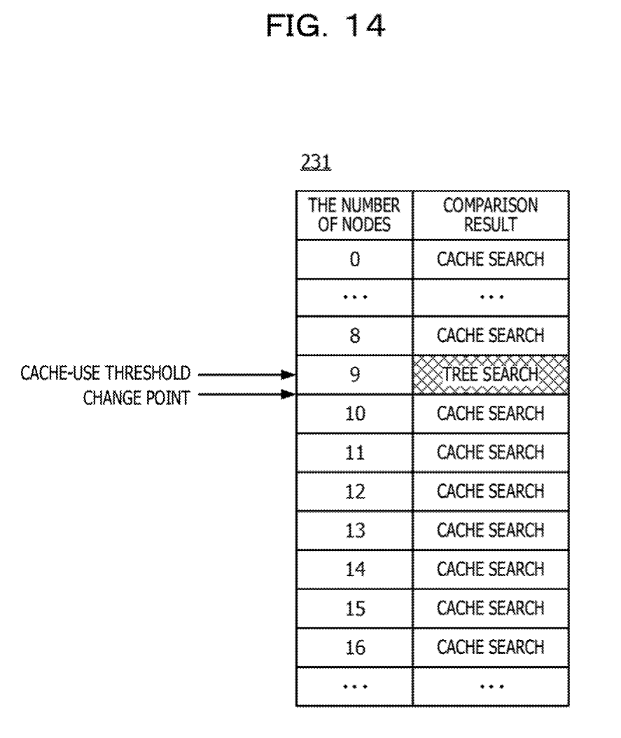

Next, the cache-use threshold determination table updated by the search unit 33 when the tree search time is shorter than the cache search time with the search key with the number “9” of nodes is illustrated in FIG. 14. FIG. 14 is a diagram illustrating one example (second example) of the cache-use threshold determination table of the third embodiment.

A cache-use threshold determination table 231 is a table resulting from updating of the cache-use threshold determination table 230 by the search unit 33 when the tree search time is shorter than the cache search time with the search key with the number “9” of nodes.

The search unit 33 updates the comparison result to “tree search” in the record of the number “9” of nodes (represented by hatching). Due to this, the search unit 33 detects a change point at the boundary between the number “9” of nodes and the number “10” of nodes. At this time, the search unit 33 decides the largest number “9” of nodes that does not exceed the change point as the cache-use threshold.

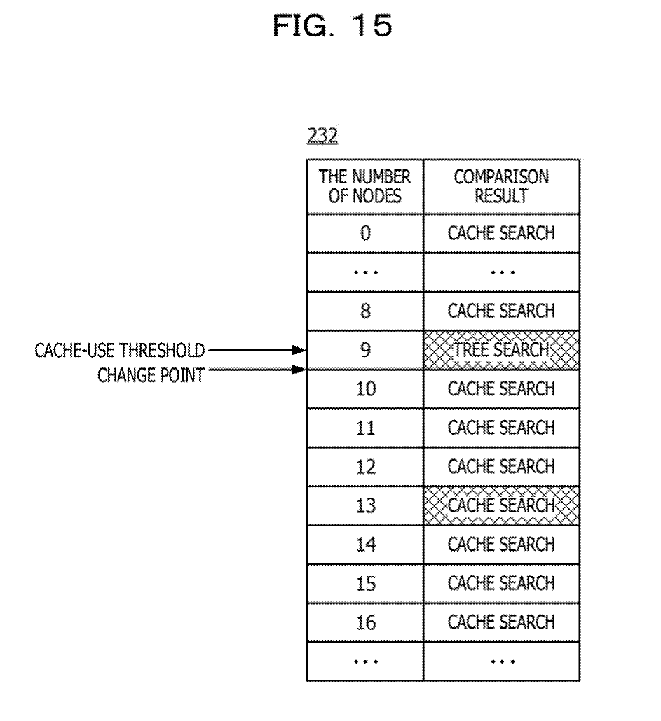

Next, the cache-use threshold determination table updated by the search unit 33 when the cache search time is shorter than the tree search time with the search key with the number “13” of nodes is illustrated in FIG. 15. FIG. 15 is a diagram illustrating one example (third example) of the cache-use threshold determination table of the third embodiment.

A cache-use threshold determination table 232 is a table resulting from updating of the cache-use threshold determination table 231 by the search unit 33 when the cache search time is shorter than the tree search time with the search key with the number “13” of nodes.

The search unit 33 updates (overwrites) the comparison result to “cache search” in the record of the number “13” of nodes (represented by hatching). However, no change is made as the substance in the record of the number “13” of nodes because the initial value of the comparison result is “cache search.” Therefore, the search unit 33 does not newly detect the change point besides the change point existing at the boundary between the number “9” of nodes and the number “10” of nodes. Thus, the search unit 33 does not update the cache-use threshold.

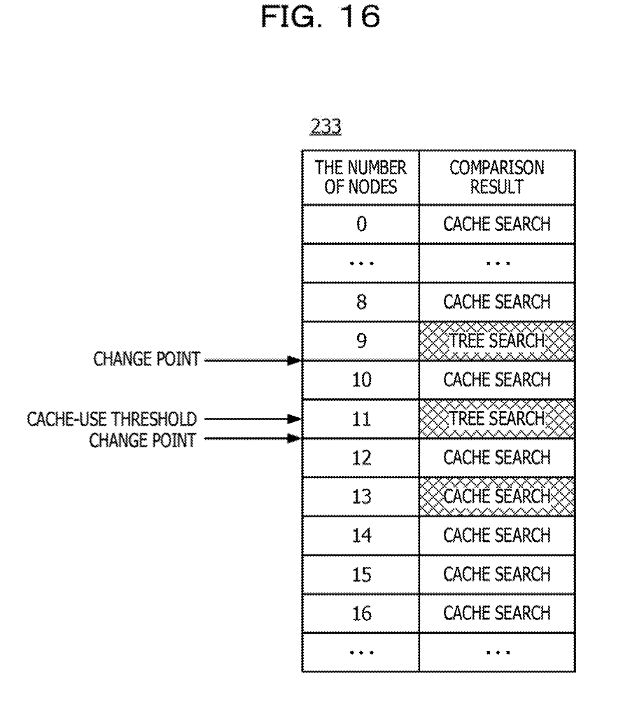

Next, the cache-use threshold determination table updated by the search unit 33 when the tree search time is shorter than the cache search time with the search key with the number “11” of nodes is illustrated in FIG. 16. FIG. 16 is a diagram illustrating one example (fourth example) of the cache-use threshold determination table of the third embodiment.

A cache-use threshold determination table 233 is a table resulting from updating of the cache-use threshold determination table 232 by the search unit 33 when the tree search time is shorter than the cache search time with the search key with the number “11” of nodes.

The search unit 33 updates the comparison result to “tree search” in the record of the number “11” of nodes (represented by hatching). Due to this, the search unit 33 detects a new change point at the boundary between the number “11” of nodes and the number “12” of nodes. Therefore, the search unit 33 detects two change points at the boundary between the number “9” of nodes and the number “10” of nodes and the boundary between the number “11” of nodes and the number “12” of nodes. The search unit 33 extracts the change point existing at the boundary between the number “11” of nodes and the number “12” of nodes in the two change points as the change point regarding which the number of nodes is the largest. At this time, the search unit 33 decides the largest number “11” of nodes that does not exceed the change point regarding which the number of nodes is the largest as the cache-use threshold.

In this manner, the search unit 33 may dynamically update the cache-use threshold. This allows the search unit 33 to carry out cache registration of the search key with which the tree search time is longer than the cache search time without carrying out cache registration of the search key with which the cache search time is longer than the tree search time.

Due to this, the search unit 33 may improve the search hit ratio when the search result is obtained in the cache search earlier than in the tree search. Furthermore, the search unit 33 improves the search performance when the search unit 33 concurrently carries out the tree search and the cache search by improving the search hit ratio of the cache search when the search result is obtained in the cache search earlier than in the tree search.

### Fourth Embodiment

Next, an L2SW of a fourth embodiment will be described. The L2SW of the fourth embodiment is different from the second embodiment and the third embodiment in that the L2SW of the fourth embodiment determines whether or not to carry out cache registration without using a threshold. The L2SW of the fourth embodiment determines whether or not to carry out cache registration by comparison between the tree search time and the cache search time instead of using a threshold. However, when the cache search results in a mishit, the original search time when the cache search results in a hit is not obtained. Thus, the search time when the cache search results in the mishit is used instead of this original search time. This is based on the fact that there is no difference between when the cache search results in a hit and when the cache search results in a mishit in that the load of the hash calculation exists. However, in a precise sense, the cache search time at the time of a mishit is slightly shorter than the cache search time at the time of a hit because match comparison of all bits with the destination IP address is not carried out.

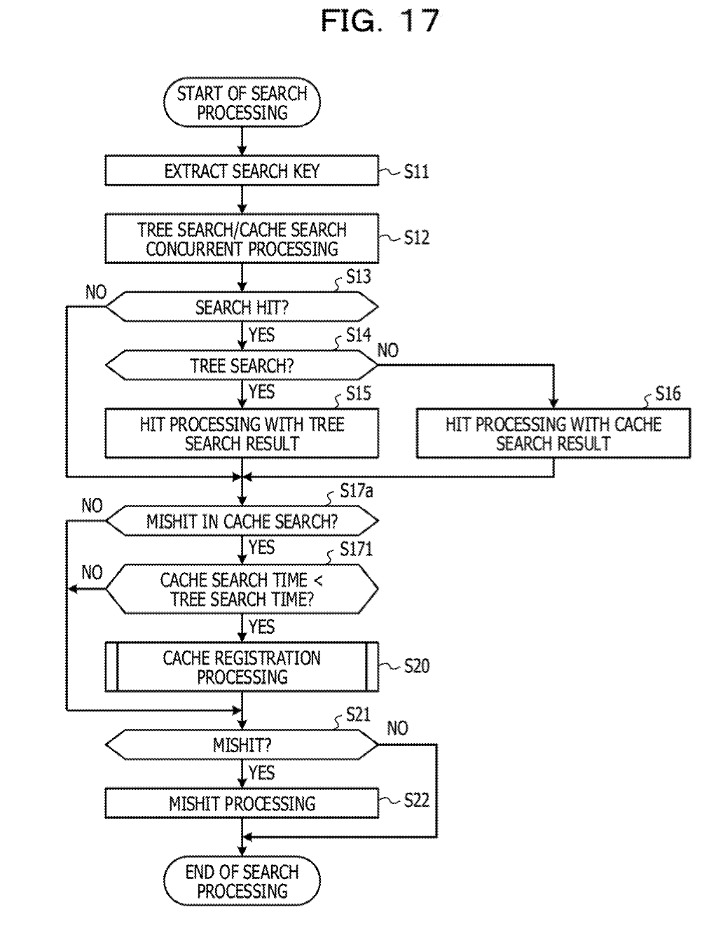

First, search processing of the fourth embodiment will be described by using FIG. 17. FIG. 17 is a diagram illustrating a flowchart of the search processing of the fourth embodiment.

The search processing is processing in which a cache search and a tree search are concurrently executed to obtain the search result. The search processing is processing executed by the search unit 33. The same processing as the search processing of the second embodiment is given the same step number and description thereof is simplified.

[Step S11] The search unit 33 extracts a search key (destination IP address) from a received packet.

[Step S12] The search unit 33 concurrently processes the tree search and the cache search by using the search key.

[Step S13] The search unit 33 determines whether or not either the tree search or the cache search has resulted in a search hit. The search unit 33 proceeds to the step S14 if either the tree search or the cache search has resulted in a search hit, and proceeds to a step S17a if neither has resulted in a search hit.

[Step S14] The search unit 33 determines whether or not the tree search has resulted in a hit. The search unit 33 proceeds to the step S15 if the tree search has resulted in a hit, and proceeds to the step S16 if the tree search has not resulted in a hit.

[Step S15] The search unit 33 executes the hit processing with the tree search result.

[Step S16] The search unit 33 executes the hit processing with the cache search result.

[Step S17a] The search unit 33 determines whether or not the cache search has resulted in a mishit. The search unit 33 proceeds to a step S171 if the cache search has resulted in a mishit, and proceeds to the step S21 if the cache search has not resulted in a mishit.

[Step S171] The search unit 33 determines whether or not the cache search time is shorter than the tree search time. The search unit 33 proceeds to the step S20 if the cache search time is shorter than the tree search time, and proceeds to the step S21 if the cache search time is not shorter than the tree search time.

However, the cache search time used here is not limited to the search time when the cache search results in a search hit, and includes the search time when the cache search results in a search mishit.

[Step S20] The search unit 33 executes the cache registration processing.

As above, the search unit 33 may determine whether or not to carry out cache registration by comparing the cache search time with the tree search time even when the cache search results in a search mishit. Therefore, the search unit 33 may determine whether or not to carry out cache registration by comparing the cache search time with the tree search time from the first packet in the cache search.

Therefore, the search unit 33 may earlier improve the search hit ratio when the search result is obtained in the cache search earlier than in the tree search. As a result, the search unit 33 improves the search performance when the search unit 33 concurrently carries out the tree search and the cache search.

[Step S21] The search unit 33 determines whether or not both of the tree search and the cache search have resulted in a search mishit. The search unit 33 proceeds to the step S22 if both of the tree search and the cache search have resulted in a search mishit, and ends the search processing if either has resulted in a search hit.

[Step S22] The search unit 33 executes the mishit processing and ends the search processing.

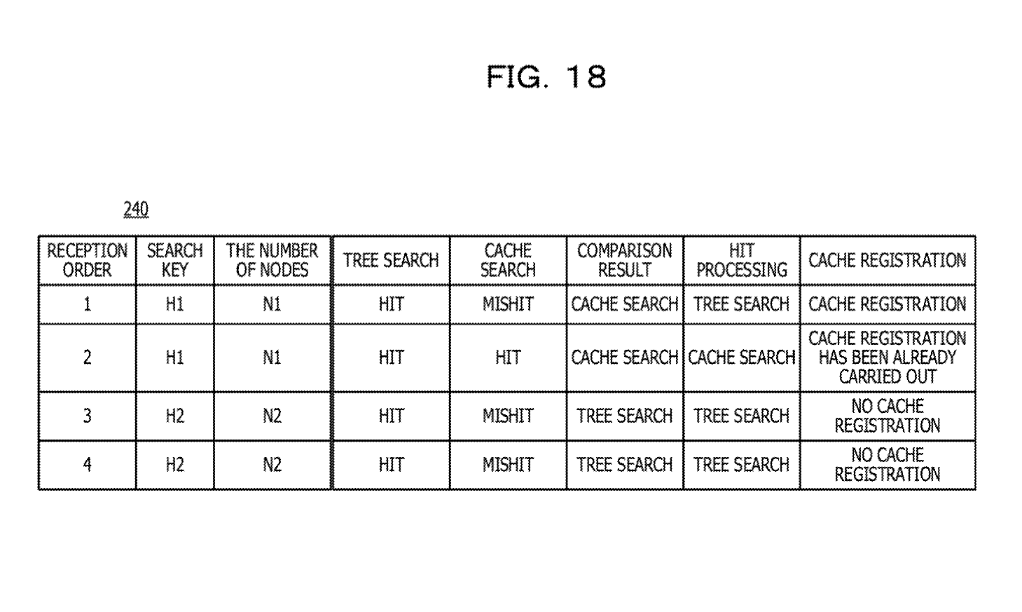

Next, a cache registration determination example will be described by using FIG. 18. FIG. 18 is a diagram illustrating the cache registration determination example of the fourth embodiment.

A cache registration determination example 240 represents a cache registration determination example in four packets from reception order “1” to reception order “4.”

First, a cache registration determination example when packets having a search key with the number of nodes with which the cache search is considered to be faster compared with the tree search are received will be described by using a cache registration determination example of the packets of reception order “1” and “2.”

The packet of reception order “1” has a search key (hash value) “H1” and the number “N1” of nodes and is a packet regarding which cache registration has not been carried out. The number “N1” of nodes is the number of nodes with which the cache search is considered to be faster compared with the tree search.

The search unit 33 makes a search regarding the packet of reception order “1.” As a result, a hit is obtained in the tree search and a mishit is obtained in the cache search. However, the search unit 33 may acquire the cache search time from the cache search resulting in the mishit in addition to acquiring the tree search time from the tree search resulting in the hit. Due to this, the search unit 33 compares the tree search time and the cache search time and obtains the comparison result that the cache search time is shorter than the tree search time. However, the search unit 33 executes the hit processing by using the search result of the tree search because the cache search has resulted in the mishit. The search unit 33 carries out cache registration of the entry corresponding to the search key “H1” in accordance with the comparison result that the cache search time is shorter than the tree search time.

The packet of reception order “2” has a search key “H1” and the number “N1” of nodes and is a packet regarding which cache registration has been carried out due to the packet of reception order “1.”

The search unit 33 makes a search regarding the packet of reception order “2.” As a result, a hit is obtained in the tree search and a hit is obtained also in the cache search. The search unit 33 acquires the tree search time from the tree search resulting in the hit and also acquires the cache search time from the cache search resulting in the hit. Due to this, the search unit 33 compares the tree search time and the cache search time to obtain the comparison result that the cache search time is shorter than the tree search time, and executes the hit processing by using the search result of the cache search.

In this manner, from the time of the first reception of the packet of the search key “H1,” the search unit 33 may compare the tree search time and the cache search time and carry out cache registration of the entry corresponding to the search key “H1.” Therefore, the search unit 33 may earlier improve the search hit ratio when the search result is obtained in the cache search earlier than in the tree search.

Next, a cache registration determination example when packets having a search key with the number of nodes with which the cache search is considered to be slower compared with the tree search are received will be described by using a cache registration determination example of the packets of reception order “3” and “4.”

The packet of reception order “3” has a search key “H2” and the number “N2” of nodes and is a packet regarding which cache registration has not been carried out. The number “N2” of nodes is the number of nodes with which the cache search is considered to be slower compared with the tree search.

The search unit 33 makes a search regarding the packet of reception order “3.” As a result, a hit is obtained in the tree search and a mishit is obtained in the cache search. However, the search unit 33 may acquire the cache search time from the cache search resulting in the mishit in addition to acquiring the tree search time from the tree search resulting in the hit. Due to this, the search unit 33 compares the tree search time and the cache search time and obtains the comparison result that the cache search time is longer than the tree search time. The search unit 33 executes the hit processing by using the search result of the tree search because the cache search has resulted in the mishit. The search unit 33 does not carry out cache registration of the entry corresponding to the search key “H2” in accordance with the comparison result that the cache search time is longer than the tree search time.

The packet of reception order “4” has a search key “H2” and the number “N2” of nodes. Regarding the packet of reception order “4,” the same processing as the packet of reception order “3” is repeated and cache registration of the entry corresponding to the search key “H2” is not carried out.

In this manner, from the time of the first reception of the packet of the search key “H2,” the search unit 33 may compare the tree search time and the cache search time and decide not to carry out cache registration of the entry corresponding to the search key “H2.” Therefore, the search unit 33 may exclude entries that do not contribute to improvement in the search hit ratio from the cache table. Accordingly, the search unit 33 may improve the search hit ratio when the search result is obtained in the cache search earlier than in the tree search.

### Fifth Embodiment

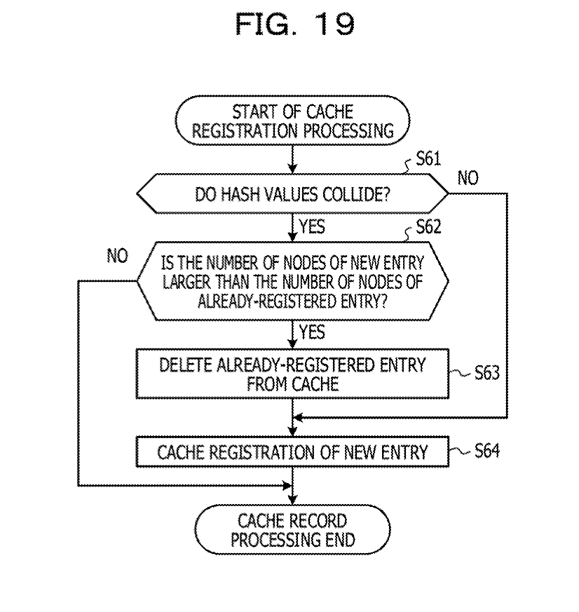

Next, an L2SW of a fifth embodiment will be described. The L2SW of the fifth embodiment is different from the second embodiment to the fourth embodiment in that the L2SW of the fifth embodiment sets the degree of priority of cache registration according to the number of nodes of the search key. In order to implement the setting of the degree of priority of cache registration, the L2SW of the fifth embodiment executes cache registration processing represented in FIG. 19 instead of the cache registration processing in the step S20 of the search processing described in the second embodiment by using FIG. 9. Furthermore, the L2SW of the fifth embodiment includes information with which the number of nodes may be identified in the cache table.

The search processing of the fifth embodiment is similar to the search processing of the second embodiment and therefore description is omitted. The cache registration processing of the fifth embodiment will be described by using FIG. 19. FIG. 19 is a diagram illustrating a flowchart of the cache registration processing of the fifth embodiment.

The cache registration processing is processing of carrying out registration of an addition-target entry after comparing the addition-target entry and a deletion-target entry based on the degree of priority and determining whether or not to carry out the registration when carrying out cache registration of the entry corresponding to the search key based on the step S18 or the step S19 of the search processing. The cache registration processing is processing executed by the search unit 33 in the step S20 of the search processing represented in FIG. 9.

[Step S61] The search unit 33 determines whether or not the hash value of the addition-target entry (new entry) collides with the hash value of an entry that has been registered in the cache table (already-registered entry). The search unit 33 proceeds to a step S62 if the hash values collide, and proceeds to a step S64 if the hash values do not collide.

[Step S62] The search unit 33 determines whether or not the number of nodes of the new entry is larger than the number of nodes of the already-registered entry. The search unit 33 proceeds to a step S63 if the number of nodes of the new entry is larger than the number of nodes of the already-registered entry, and ends the cache registration processing if the number of nodes of the new entry is not larger than the number of nodes of the already-registered entry.

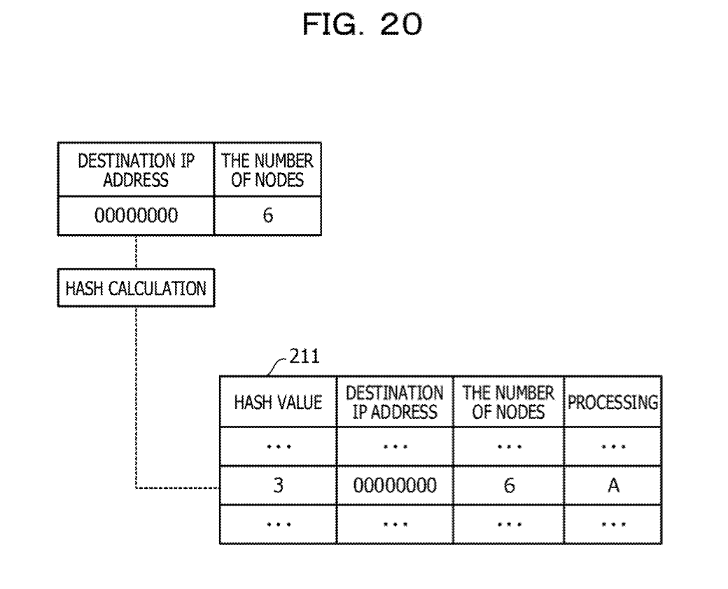

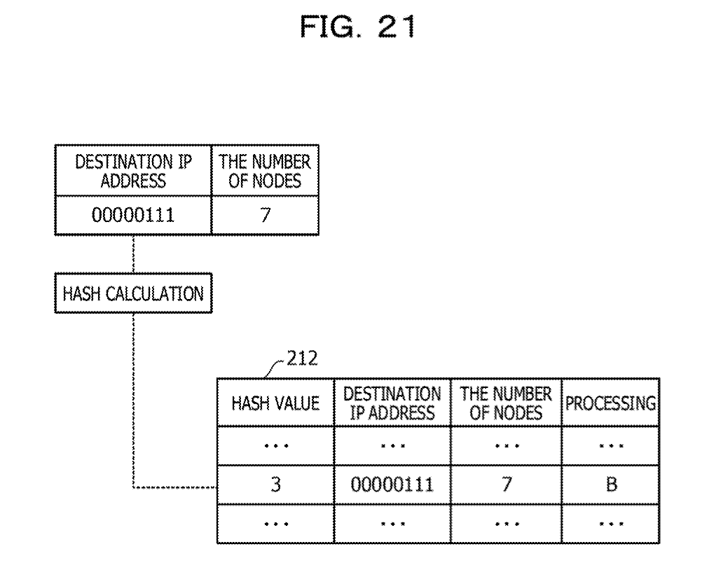

The search unit 33 may acquire the number of nodes of the already-registered entry from the cache table. The cache table of the fifth embodiment will be described later by using FIG. 20 and FIG. 21.

[Step S63] The search unit 33 deletes the already-registered entry from the cache table.

[Step S64] The search unit 33 registers the new entry in the cache table (cache registration) and ends the cache registration processing.

In this manner, if hash values collide, the search unit 33 determines the validity of cache registration regarding the new entry and the already-registered entry by comparing the number of nodes of the entry. For example, the number of nodes of the entry is priority information equivalent to the degree of priority of cache registration.

Next, the cache table of the fifth embodiment will be described by using FIG. 20 and FIG. 21. First, an entry registered in the cache table in advance (already-registered entry) will be described by using FIG. 20. FIG. 20 is a diagram illustrating one example (first example) of the cache table of the fifth embodiment.

A cache table 211 is data updated in the cache search and is stored in the memory 101. The cache table 211 is one mode of the forwarding table and has a table data structure including the hash value of the destination IP address (search key) as an index. For example, the cache table 211 includes an item “hash value,” an item “destination IP address,” an item “the number of nodes,” and an item “processing.”

The item “hash value” indicates the result of hash calculation when the destination IP address (search key) is deemed as an input value. The search key “00000000” has a hash value “3” and the number “6” of nodes and is associated with processing “A.”

Next, an entry additionally registered in the cache table 211 (new entry) will be described by using FIG. 21. FIG. 21 is a diagram illustrating one example (second example) of the cache table of the fifth embodiment.

A cache table 212 is a cache table resulting from updating of the cache table 211 due to additional registration of the new entry.

The new entry has a destination IP address (search key) “00000111,” a hash value “3,” and the number “7” of nodes. Therefore, the hash value of the new entry collides with the hash value “3” of the already-registered entry. Here, the search unit 33 compares the number “6” of nodes of the already-registered entry acquired from the cache table 211 and the number “7” of nodes of the new entry. Because the number of nodes of the new entry is larger than the number of nodes of the already-registered entry, the search unit 33 registers the new entry in priority to the already-registered entry (overwrites the already-registered entry) to obtain the cache table 212.

Therefore, in the cache table 212, the new entry with which the search key “00000111,” the hash value “3,” the number “7” of nodes, and processing “B” are associated is registered.

If the new entry has a hash value “3” and the number “5” of nodes, the search unit 33 cancels registration of the new entry and does not update the cache table 211.

This allows the search unit 33 to exclude entries that do not contribute to improvement in the search hit ratio from the cache table. Therefore, the search unit 33 may improve the search hit ratio when the search result is obtained in the cache search earlier than in the tree search.

The search unit 33 refers to the number of nodes and determines whether or not to carry out registration when the hashes collide. However, the configuration is not limited thereto and the search unit 33 may refer to the number of nodes and determine whether or not to carry out cache registration in the case in which replacement of the entry occurs, such as the case in which the number of entries has reached the upper limit.

### Sixth Embodiment

Next, an L2SW of a sixth embodiment will be described. The L2SW of the sixth embodiment is different from the fifth embodiment in that the L2SW of the sixth embodiment carries out setting of the degree of priority of cache registration according to the bandwidth (communication amount) of the packet as the search target in addition to setting of the degree of priority of cache registration according to the number of nodes of the search key.

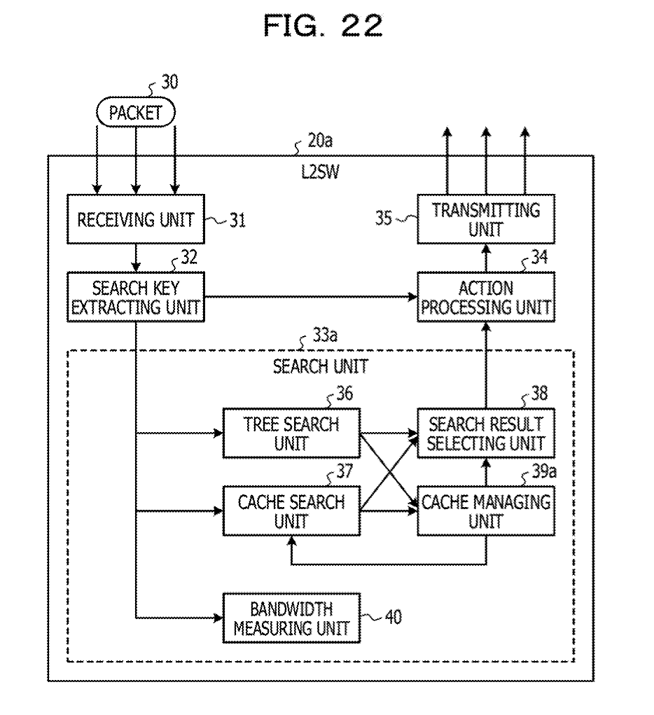

First, the functional configuration of the L2SW of the sixth embodiment will be described by using FIG. 22. FIG. 22 is a diagram illustrating one example of the functional configuration of the L2SW of the sixth embodiment. The same configuration as the L2SW 20 of the second embodiment is given the same symbol and description is omitted.

An L2SW 20a includes the receiving unit 31, the search key extracting unit 32, a search unit 33a, the action processing unit 34, and the transmitting unit 35.

The search unit 33a carries out a search based on a search key input from the search key extracting unit 32 and outputs the search result to the action processing unit 34. The search unit 33a includes the tree search unit 36, the cache search unit 37, the search result selecting unit 38, a cache managing unit 39a, and a bandwidth measuring unit 40. The tree search unit 36 searches a tree table by a tree search system with use of the search key. The cache search unit 37 searches a cache table by a cache search system with use of the search key.

The search result selecting unit 38 selects the search result obtained earlier in a search result obtained from the tree search unit 36 and a search result obtained from the cache search unit 37 and outputs the search result to the action processing unit 34.

The bandwidth measuring unit 40 measures the bandwidth of each search key and outputs the measurement result to the cache managing unit 39a. For example, the bandwidth measuring unit 40 outputs the communication amount per unit time (for example, one second) to the cache managing unit 39a at given intervals (for example, 10 seconds).

The cache managing unit 39a updates the cache table based on the search result obtained from the tree search unit 36 and the search result obtained from the cache search unit 37. Furthermore, the bandwidth measurement result of each search key (entry) is input to the cache managing unit 39a from the bandwidth measuring unit 40 and the cache managing unit 39a records the bandwidth measurement result in the cache table.

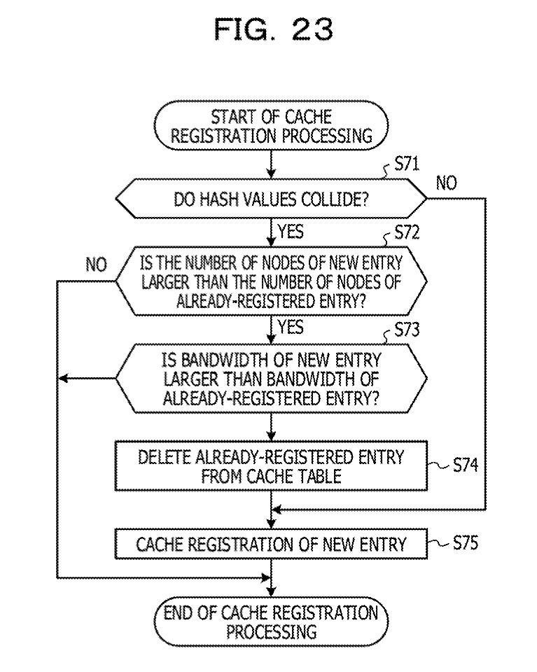

In order to implement the setting of the degree of priority of cache registration, the L2SW 20a executes cache registration processing represented in FIG. 23 instead of the cache registration processing in the step S20 of the search processing described in the second embodiment by using FIG. 9. Furthermore, the L2SW 20a includes, in the cache table, information with which the number of nodes may be identified and information with which the bandwidth of each search key may be evaluated.

The search processing of the sixth embodiment is similar to the search processing of the second embodiment and therefore description is omitted. The cache registration processing of the sixth embodiment will be described by using FIG. 23. FIG. 23 is a diagram illustrating a flowchart of the cache registration processing of the sixth embodiment.

The cache registration processing is processing of carrying out registration of an addition-target entry after comparing the addition-target entry and a deletion-target entry based on the degree of priority and determining whether or not to carry out the registration when carrying out cache registration of the entry corresponding to the search key based on the step S18 or the step S19 of the search processing. The cache registration processing is processing executed by the search unit 33a in the step S20 of the search processing represented in FIG. 9.

[Step S71] The search unit 33a determines whether or not the hash value of the addition-target entry (new entry) collides with the hash value of an entry that has been registered in the cache table (already-registered entry). The search unit 33a proceeds to a step S72 if the hash values collide, and proceeds to a step S75 if the hash values do not collide.

[Step S72] The search unit 33a determines whether or not the number of nodes of the new entry is larger than the number of nodes of the already-registered entry. The search unit 33a proceeds to a step S73 if the number of nodes of the new entry is larger than the number of nodes of the already-registered entry, and ends the cache registration processing if the number of nodes of the new entry is not larger than the number of nodes of the already-registered entry.

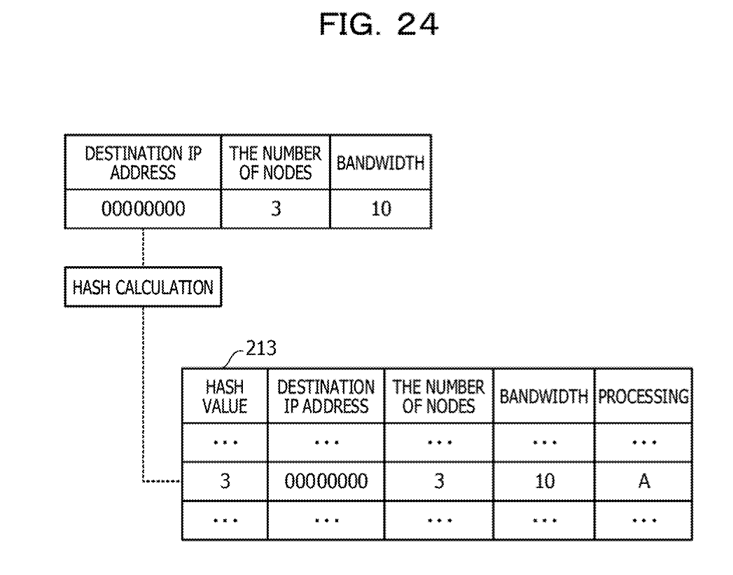

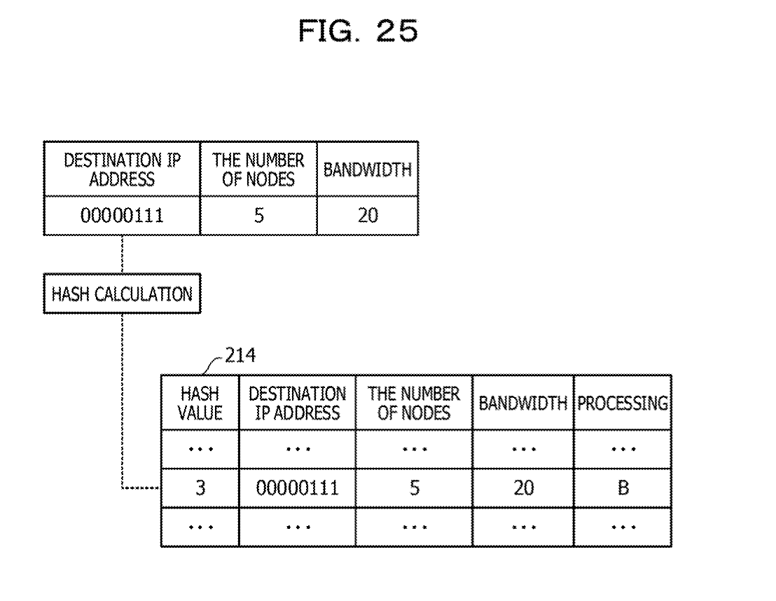

The search unit 33a may acquire the number of nodes of the already-registered entry from the cache table. The cache table of the sixth embodiment will be described later by using FIG. 24 and FIG. 25.

[Step S73] The search unit 33a determines whether or not the bandwidth of the new entry is larger than the bandwidth of the already-registered entry. The search unit 33a proceeds to a step S74 if the bandwidth of the new entry is larger than the bandwidth of the already-registered entry, and ends the cache registration processing if the bandwidth of the new entry is not larger than the bandwidth of the already-registered entry.

The search unit 33a may acquire the bandwidth of the already-registered entry from the cache table.

[Step S74] The search unit 33a deletes the already-registered entry from the cache table.

[Step S75] The search unit 33a registers the new entry in the cache table (cache registration) and ends the cache registration processing.

In this manner, if hash values collide, the search unit 33a determines the validity of cache registration regarding the new entry and the already-registered entry from comparison of the number of nodes of the entry and comparison of the bandwidth. For example, the number of nodes of the entry is priority information equivalent to the first degree of priority of cache registration and the bandwidth of the entry is priority information equivalent to the second degree of priority of cache registration.

Next, the cache table of the sixth embodiment will be described by using FIG. 24 and FIG. 25. First, an entry registered in the cache table in advance (already-registered entry) will be described by using FIG. 24. FIG. 24 is a diagram illustrating one example (first example) of the cache table of the sixth embodiment.

A cache table 213 is data updated in the cache search and is stored in the memory 101. The cache table 213 is one mode of the forwarding table and has a table data structure including the hash value of the destination IP address (search key) as an index. For example, the cache table 213 includes an item “hash value,” an item “destination IP address,” an item “the number of nodes,” an item “bandwidth,” and an item “processing.”

The item “hash value” indicates the result of hash calculation when the destination IP address (search key) is deemed as an input value. The search key “00000000” has a hash value “3,” the number “3” of nodes, and bandwidth “10 (megabits per second (Mbps))” and is associated with processing “A.”

Next, an entry additionally registered in the cache table 213 (new entry) will be described by using FIG. 25. FIG. 25 is a diagram illustrating one example (second example) of the cache table of the sixth embodiment.

A cache table 214 is a cache table resulting from updating of the cache table 213 due to additional registration of the new entry.

The new entry has a destination IP address (search key) “00000111,” a hash value “3,” the number “5” of nodes, and bandwidth “20.” Therefore, the hash value of the new entry collides with the hash value “3” of the already-registered entry. Here, the search unit 33a compares the number “3” of nodes of the already-registered entry acquired from the cache table 213 and the number “5” of nodes of the new entry and carries out a first priority determination. Because the number of nodes of the new entry is larger than the number of nodes of the already-registered entry, the search unit 33a deems that the result of the first priority determination is the positive determination regarding the new entry, and carries out a second priority determination. The search unit 33a compares the bandwidth “10” of the already-registered entry acquired from the cache table 213 and the bandwidth “20” of the new entry and carries out the second priority determination. Because the bandwidth of the new entry is larger than the bandwidth of the already-registered entry, the search unit 33a deems that the result of the second priority determination is the positive determination regarding the new entry, and carries out cache registration.

Due to this, the search unit 33a registers the new entry in priority to the already-registered entry (overwrites the already-registered entry) to obtain the cache table 214.

Therefore, in the cache table 214, the new entry with which the search key “00000111,” the hash value “3,” the number “5” of nodes, the bandwidth “20,” and processing “B” are associated is registered.

If the new entry has a hash value “3” and the number “2” of nodes of if the new entry has a hash value “3,” the number “5” of nodes, and bandwidth “1,” the search unit 33a cancels registration of the new entry and does not update the cache table 213.

This allows the search unit 33a to exclude entries that do not contribute to improvement in the search hit ratio from the cache table. Furthermore, the search unit 33a may set many opportunities for a search hit regarding packets having many opportunities for a search by using bandwidth information as priority information. Therefore, the search unit 33a may improve the search hit ratio when the search result is obtained in the cache search earlier than in the tree search.

The search unit 33a refers to the number of nodes and determines whether or not to carry out registration when the hashes collide. However, the configuration is not limited thereto and the search unit 33a may refer to the number of nodes and determine whether or not to carry out cache registration in the case in which replacement of the entry occurs, such as the case in which the number of entries has reached the upper limit.

The above-described processing functions may be implemented by a computer. In this case, a program is offered in which the contents of processing of functions that may be possessed by a data forwarding device such as the switch 1, the router 13, 15, 17, 21, or 24, or the L2SW 16, 20, or 20a are described. Furthermore, the search key extracting unit 32, the search units 33 and 33a, the action processing unit 34, and so forth have one aspect as a data forwarding control device and a program in which the contents of processing of functions that may be possessed by the data forwarding control device are described is offered. The program is executed by the computer and thereby the above-described processing functions are implemented on the computer. The program in which the contents of processing are described may be recorded in a computer-readable recording medium. As the computer-readable recording medium, magnetic storing device, optical disc, magneto-optical recording medium, semiconductor memory, and so forth exist. Examples of the magnetic storing device include hard disc device (HDD), flexible disc (FD), magnetic tape, and so forth. Examples of the optical disc include DVD, DVD-RAM, CD-ROM/RW, and so forth. Examples of the magneto-optical recording medium include a magneto-optical disk (MO) and so forth.

In the case of distributing the program, portable recording media such as DVD and CD-ROM in which the program is recorded are sold, for example. Furthermore, it is also possible to store the program in a storing device of a server computer and transfer the program from the server computer to another computer through a network.

The computer that executes the program stores the program recorded in the portable recording medium or the program transferred from the server computer in an own storing device, for example. Then, the computer reads the program from the own storing device and executes processing in accordance with the program. It is also possible for the computer to directly read the program from the portable recording medium and execute program in accordance with the program. Furthermore, it is also possible for the computer to execute processing in accordance with a received program in a timely manner every time the program is transferred from the server computer coupled through a network.

Moreover, it is also possible to implement at least part of the above-described processing functions by an electronic circuit such as DSP, ASIC, or PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A switch comprising:
a memory that stores tree data used for a tree search in which a search for a forwarding destination of received data is made by a tree search system and cache data used for a cache search in which a search for the forwarding destination is made by a cache search system; and
a controller that concurrently carries out the tree search and the cache search based on forwarding control identification information included in the received data and decides the forwarding destination of the received data in accordance with a search result that is obtained earlier in search results of the tree search and the cache search.

2. The switch according to claim 1, wherein
the controller registers an entry corresponding to the forwarding control identification information in the cache data when the search result of the cache search is a mishit and when the cache search based on the forwarding control identification information is capable of obtaining the search result earlier than the tree search based on the forwarding control identification information.

3. The switch according to claim 2, wherein
the memory stores a threshold set in advance, and
the controller estimates that the cache search based on the forwarding control identification information is capable of obtaining the search result earlier than the tree search based on the forwarding control identification information when the number of nodes of the tree search based on the forwarding control identification information is larger than the threshold.

4. The switch according to claim 2, wherein
the memory stores a threshold that is dynamically updated,
the controller updates the threshold based on a result of comparison between the number of nodes of the tree search based on the forwarding control identification information and the number of nodes corresponding to the forwarding control identification information used for the cache search, and
the controller estimates that the cache search based on the forwarding control identification information is capable of obtaining the search result earlier than the tree search based on the forwarding control identification information when the number of nodes of the tree search based on the forwarding control identification information is larger than the threshold.

5. The switch according to claim 2, wherein
the controller estimates that the cache search based on the forwarding control identification information is capable of obtaining the search result earlier than the tree search based on the forwarding control identification information when the number of nodes of the tree search based on the forwarding control identification information is larger than the number of nodes corresponding to the forwarding control identification information with which the cache search results in a mishit.

6. The switch according to claim 2, wherein
the cache data includes a hash value of the forwarding control identification information and the number of nodes corresponding to the forwarding control identification information, and when entries that overlap in the hash value of the forwarding control identification information exist when an entry corresponding to the forwarding control identification information is registered in the cache data, the controller registers an entry regarding which the number of nodes is larger in the entries that overlap in the cache data and does not register an entry regarding which the number of nodes is smaller in the cache data.

7. The switch according to claim 6, wherein
the cache data further includes bandwidth information relating to communication bandwidth of each piece of the forwarding control identification information, and when entries that overlap in the hash value of the forwarding control identification information exist when an entry corresponding to the forwarding control identification information is registered in the cache data, the controller registers an entry regarding which the communication bandwidth identified by the bandwidth information is larger in the entries that overlap in the cache data and does not register an entry regarding which the communication bandwidth is smaller in the cache data.

8. A communication method carried out by a processor coupled to a memory, the communication method comprising:
making a search for a forwarding destination of received data by a tree search system with use of tree data recorded in the memory;
simultaneously making a search for the forwarding destination of the received data by a cache search system with use of cache data recorded in the memory; and
deciding the forwarding destination of the received data in accordance with a search result that is obtained earlier in search results of the tree search and the cache search.
